(19) United States
(12) Patent Application Publication
(10) Pub. No.: US 2004/0208630 A1
(43) Pub. Date: Oct. 21, 2004

(54) Method of sampling local and remote feedback in an optical wireless link

(76) Inventors: Eric G. Oettinger, Rochester, MN (US); Mark D. Heminger, Rochester, MN (US); Mark W. Heaton, Irving, TX (US)

Correspondence Address: TEXAS INSTRUMENTS INCORPORATED, P O BOX 655474, M/S 3999, DALLAS, TX, 75265

(21) Appl. No.: 10/145,989

(22) Filed: May 14, 2002

(51) Int. Cl. H04B 10/00

(52) U.S. Cl. 398/167

(57) ABSTRACT

A technique for integrating both local and remote feedback in an optical wireless communication link in a manner that simultaneously minimizes network overhead and maintains a high bandwidth loop sufficient to control the resonances of the mirror.

### BACKGROUND OF THE INVENTION

1. Field of the Invention

This invention relates generally to optical wireless communication links, and more particularly, to a method of sampling local and remote feedback in an optical wireless link.

2. Description of the Prior Art

An optical wireless link system consists of two stations (OWLs): Each of which contains an optical transmitter and an optical receiver. The transmitter is able to change the direction of its transmitted beam by known amounts of angular displacement. The receiver sees this motion and sends position correction information back to the transmitter. This feedback is used by a servo control loop to position the transmitted beam on the receiver of the remote station.

There are two sensors in each unit of an optical wireless link (OWL). The first can be used to measure the direction of the transmitted beam relative to the station in which the transmitter is mounted. The data from the second sensor is used by the remote station after transmission across the link; it senses the position of the incident beam from the remote station relative to the local data receiver. The control system must use these two measurements (the local position sensor, and the position feedback from the remote station) as inputs to calculate a control effort output, i.e. this is a multi-input, single-output system. This multi-input structure is problematic however, since the control loop must run with a fairly high sample rate in order to maintain a high bandwidth loop that is sufficient to control the resonances of the mirror; while a lower sample rate is desirable in order to minimize network overhead.

In view of the foregoing, it would be desirable and advantageous in the optical wireless communication art to provide a technique for integrating both local and remote feedback in an optical wireless communication link in a manner that simultaneously minimizes network overhead and maintains a high bandwidth loop sufficient to control the resonances of the mirror.

### SUMMARY OF THE INVENTION

The present invention is directed to a technique for integrating both local and remote feedback in an optical wireless communication link in a manner that simultaneously minimizes network overhead and maintains a high bandwidth loop sufficient to control the resonances of the mirror.

The local sensor is sampled at a high rate that allows the loop to track any locally detectable vibrations. The dominant vibration will be at the mirror's resonant frequency and should be detectable (and controllable) using the local feedback only.

The purpose of the remote feedback is to compensate for relative motion between the two units, this motion is likely to be of a lower frequency, as the mass of the unit prevents it from vibrating very rapidly. The remote unit can therefore be sampled and transmitted across the link at a slower rate due to the lower frequency requirements.

The control loop is configured such that the local sensor is used in the feedback loop; while the remote sensor is simply used to update the reference target.

In one aspect of the invention, a method is provided for integrating both local and remote feedback in an optical wireless communication link in a manner that determines a single control effort output.

In another aspect of the invention, a method is provided for integrating both local and remote feedback in an optical wireless communication link in a manner that minimizes network overhead while allowing the control loop to run with a fairly high sample rate.

In still another aspect of the invention, a method is provided for integrating both local and remote feedback in an optical wireless communication link in a manner that allows each feedback source to run at a sample rate that is distinct unto itself.

In still another aspect of the invention, a method is provided for integrating both local and remote feedback in an optical wireless communication link in a manner that provides immunity to missed remote samples.

According to one embodiment, an optical wireless link (OWL) comprises a transmitter; a receiver; and a control loop, wherein the control loop generates a mirror control signal in response to feedback information provided at a first sample rate from a remote OWL, and further in response to feedback information provided at a second sample rate in response to a local sensor.

According to another embodiment, an optical wireless link (OWL) comprises a control loop, wherein the control loop generates a mirror control signal in response to feedback information provided at a first sample rate from a remote OWL, and further in response to feedback information provided at a second sample rate in response to a local sensor.

According to yet another embodiment, a method of optical wireless communication comprising the steps of providing an optical wireless link (OWL) having a transmitter, a receiver, and a control loop; receiving feedback information from a remote OWL at a servo sample rate; generating sensor feedback information via the control loop at a second sample rate; and combining the feedback information from a remote OWL at a servo sample rate with the sensor feedback information at a second sample rate to generate a mirror movement control signal.

According to still another embodiment, an optical wireless link (OWL) comprising means for generating a mirror movement control signal in response to feedback information provided at a servo sample rate from a remote OWL, and further in response to feedback information provided at a local sensor sample rate.

### BRIEF DESCRIPTION OF THE DRAWINGS

Other aspects, features and advantages of the present invention will be readily appreciated, as the invention becomes better understood by reference to the following detailed description when considered in connection with the accompanying drawing figures wherein:

FIG. 1 is a block diagram illustrating a pair of OWLs communicating with one another in which each OWL includes a transmitter, receiver and a processor/controller; and

FIG. 2 is a block diagram illustrating a control loop in an optical wireless link according to one embodiment of the present invention.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

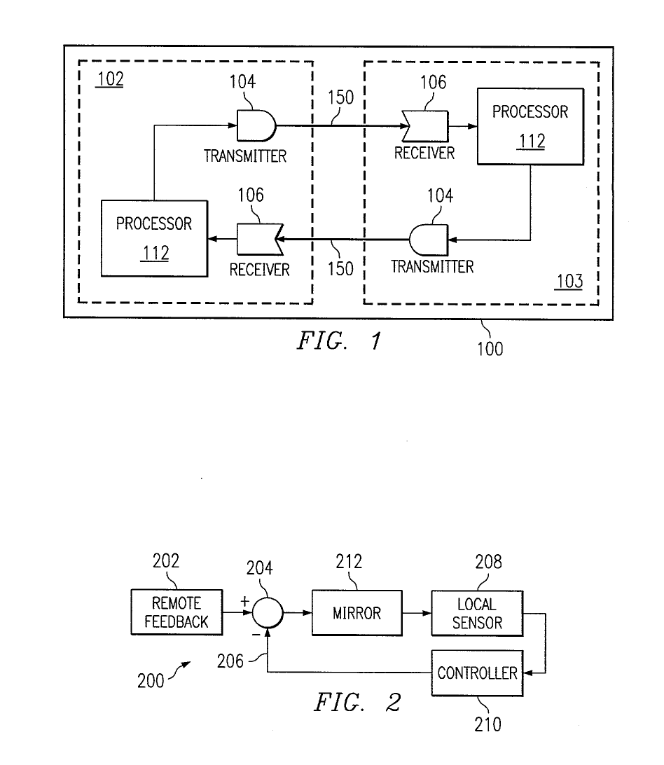

FIG. 1 is a block diagram illustrating an OWL system 100 having a pair of OWLs 102, 103 communicating with one another in which each OWL includes a transmitter 104, a receiver 106 and a processor 112. The transmitter 104 is able to change the direction of its transmitted beam by known amounts of angular displacement. The receiver 106 sees this motion as a linear displacement, and sends position correction information back to the remote station via transmitter 104. This feedback is used by a servo control loop algorithm to position the transmitted beam on the receiver 106 of the remote station.

There are two sensors in each unit located in proximity to transmitter 104, and receiver 106 of an OWL 102, 103. The OWL control system must use measurements provided by these two sensors as inputs to calculate a control effort output as this is a multi-input, single-output system. In view of the foregoing, a technique for integrating these two feedback sources is now described herein below.

FIG. 2 is a block diagram illustrating a control loop 200 in an optical wireless link such as OWL 102, 103 depicted in FIG. 1, according to one embodiment of the present invention. Control loop 200 provides a technique for integrating both local and remote feedback in an optical wireless communication link in a manner that simultaneously minimizes network overhead and maintains a high bandwidth loop sufficient to control the resonance of the mirror. Control loop 200 then allows a technique for controlling the resonance of the mirror by allowing the control loop to run with a fairly high sample rate. Network overhead is simultaneously minimized using a slower sample rate for the remote feedback.

With continued reference now to FIG. 2, control loop 200 can be seen to have a remote feedback input 202 transmitted from a remote OWL that is combined via a combinatorial element 204 with a second feedback input 206 that is provided in response to a local sensor 208 and loop controller 210. The system architecture provided by control loop 200 can be seen to allow use of different sample rates for the two feedback sources 202, 208, since each feedback source 202, 208 functions independently of the other, except to combine 204 the two measurements as inputs to calculate a control effort output for controlling the mirror 212. The local sensor 208 is then sampled at a high rate which allows the control loop 200 to track any locally detectable vibrations. The dominant vibration will be at the mirror's 212 resonant frequency, and should be detectable (and controllable) using only the local feedback provided via local sensor 208 and loop controller 210.

The purpose of the remote feedback 202 is to compensate for relative motion between the two OWLs 102, 103. This motion is likely to be of a lower frequency, as the mass of an OWL prevents it from vibrating very rapidly. With the lower frequency requirements, the remote OWL can be sampled; and its feedback information can be transmitted across the link (enumerated as 150 in FIG. 1) at a slower rate. Importantly, tracking a low frequency motion with a large amplitude or at long distances will still require a substantially high bandwidth.

Those skilled in the art will readily appreciate that control loop 200 then is configured such that the local sensor 208 is used in the local feedback loop, and the remote sensor is simply used to update the reference target. This configuration also provides immunity to missed remote samples, which would be more difficult to handle if the remote position was used in the feedback path containing the local sensor 208.

In view of the above, it can be seen the present invention presents a significant advancement in the art of optical wireless communication techniques. Further, this invention has been described in considerable detail in order to provide those skilled in the optical wireless communication art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. An optical wireless link (OWL) comprising:
a transmitter;
a receiver; and
a control loop, wherein the control loop generates a mirror control signal in response to feedback information provided at a first sample rate from a remote OWL, and further in response to feedback information provided at a second sample rate in response to a local sensor.

2. The OWL according to claim 1, wherein the control loop comprises:
a mirror;
a local sensor operational to generate a local sensor signal in response to mirror position;
a controller operational in response to the local sensor signal to generate the feedback information provided at a second sample rate; and
a combinatorial element configured to combine the feedback information provided at a first sample rate from a remote OWL, and the feedback information provided at a second sample rate from the controller, such that the feedback information provided at a first sample rate and the feedback information provided at a second sample rate together control the mirror position.

3. An optical wireless link (OWL) comprising a control loop, wherein the control loop generates a mirror control signal in response to feedback information provided at a first sample rate from a remote OWL, and further in response to feedback information provided at a second sample rate in response to a local sensor.

4. The OWL according to claim 3, further comprising:
a transmitter; and
a receiver configured to receive the remote feedback information provided at a first sample rate from a remote OWL.

5. The OWL according to claim 3 wherein the control loop comprises:
a mirror;
a local sensor operational to generate a local sensor signal in response to mirror position;
a controller operational in response to the local sensor signal to generate the feedback information provided at a second sample rate; and
a combinatorial element configured to combine the feedback information provided at a first sample rate from a remote OWL, and the feedback information provided at a second sample rate from the controller, such that the feedback information provided at a first sample rate and the feedback information provided at a second sample rate together control the mirror position.

6. A method of optical wireless communication comprising the steps of:
providing an optical wireless link (OWL) having a transmitter, a receiver, and a control loop;
receiving feedback information from a remote OWL at a first sample rate;
generating sensor feedback information via the control loop at a second sample rate; and
combining the feedback information from a remote OWL at a first sample rate with the sensor feedback information at a second sample rate to generate a mirror position control signal.

7. The method of claim 6 wherein the first sample rate is substantially slower than the second sample rate.

8. An optical wireless link (OWL) comprising means for generating a mirror position control signal in response to feedback information provided at a feedback sample rate from a remote OWL, and further in response to sensor information provided at a local sensor sample rate.

9. The OWL according to claim 8 wherein the means for generating a mirror position control signal comprises:
a mirror;
means responsive to mirror position for generating the feedback information provided at a local sensor sample rate; and
a combinatorial element configured to combine the feedback information provided at a feedback sample rate from a remote OWL, and the feedback information provided at a local sensor sample rate, such that the feedback information provided at the remote feedback rate and the feedback information provided at the local sensor sample rate together control the mirror position.

10. The OWL according to claim 9 wherein the means responsive to mirror position for generating the feedback information provided at a local sensor sample rate comprises:
a local sensor configured to generate a local sensor signal in response to mirror position; and
a controller configured to generate the feedback information provided at a local sensor sample rate in response to the local sensor signal.
